(19) United States
(12) Patent Application Publication
(10) Pub. No.: US 2026/0257233 A1
(43) Pub. Date: Sep. 3, 2026

(54) LIQUID DISPENSING SYSTEM WITH INTERNAL RECIRCULATION

(71) Applicant: Spraying Systems Co., Wheaton, IL (US)

(72) Inventors: Thomas E. Ackerman, Francestown, NH (US); Jason Tyler Rusch, Hollia, NH (US)

(21) Appl. No.: 18/652,955

(22) PCT Filed: Oct. 21, 2022
(86) PCT No.: PCT/US2022/047360

§ 371 Date: May 2, 2024

Related U.S. Application Data
(60) Provisional application No. 63/274,651, filed on Nov. 2, 2021.

(51) Int. Cl. B05B 5/03; B05B 5/16; B05B 15/58; F26B 3/12

(52) U.S. Cl. CPC B05B 5/03; B05B 5/16; B05B 15/58; F26B 3/12

(57) ABSTRACT

An electrostatic spray nozzle assembly (16) having fluid delivery and return tubes (36, 60) coupled to a common fluid supply. A piston assembly (50) having a shut off head (50b) is moveable between (1) a retracted position that permits fluid flow from the fluid supply through the delivery tube (36) for discharge from a spray tip discharge orifice (38c) while blocking the communication of fluid through the fluid return tube (60) and (2) an extended position that blocks the fluid flow to the spray tip discharge orifice (38c) while directing fluid to the return tube (60) for recirculation in said fluid supply (21). An atomizing gas directing tube (31) is supported in surrounding relation to the fluid delivery tube (36), and the fluid delivery and return tubes (36, 60) and other internal flow directing components of the spray nozzle assembly are electrically charged in relation for enhanced electrostatic spraying.

### CROSS-REFERENCE TO RELATED APPLICATION

This patent application claims the benefit of U.S. Provisional Patent Application No. 63/274,651, filed Nov. 2, 2021 and PCT International Patent Application No. PCT/US 2022/047360, filed Oct. 21, 2022 which are incorporated by reference.

### FIELD OF THE INVENTION

The present invention relates to liquid spray nozzle assemblies, and more particularly, to electrostatic spray drying nozzle assemblies particularly adapted for spraying an emulsion or suspension comprising a solvent and solids into a hot gas stream.

### BACKGROUND OF THE INVENTION

Electrostatic spray dryers are known to have particular utility in spraying liquid containing solids into fine particles that are directed into a hot gas stream that evaporates the solvent and leaves the solids in powder form. The greater the solids content in the suspension, there is less solvent and hence less energy required to evaporate the solvent. Starting with a solvent suspension that has a high solids content hence is beneficial for saving operating cost. With higher solids content, however, operating complications can result, one being that when the fluid system is paused, the solids tend to fall out of suspension quickly building up throughout the spraying system creating clogging that interrupts efficient or continued operation. One particular location for clogging is the spray nozzle.

### OBJECTS AND SUMMARY OF THE INVENTION

It is an object of the present invention to provide a spray drying system operable for more efficiently and effectively drying high solids containing solvents.

Another object to provide an electrostatic spray drying system as characterized above which has a spray nozzle assembly operable for spraying high solids containing solvents without undesirable clogging.

Further object is to provide an a spray nozzle assembly in which solids containing solvent is recirculated substantially throughout the spray nozzle during shut off conditions for preventing solids build up and clogging within the spray nozzle.

Still another object is to provide a spray nozzle assembly of the foregoing type that is relatively simple in design and lends itself to economical manufacture.

Other objects and advantages of the invention will become apparent upon reading the following detailed description and upon reference to the drawings.

### BRIEF DESCRIPTION OF THE DRAWINGS

FIG. 1 is a diagrammatic depiction of an illustrated spray drying system in accordance with the invention;

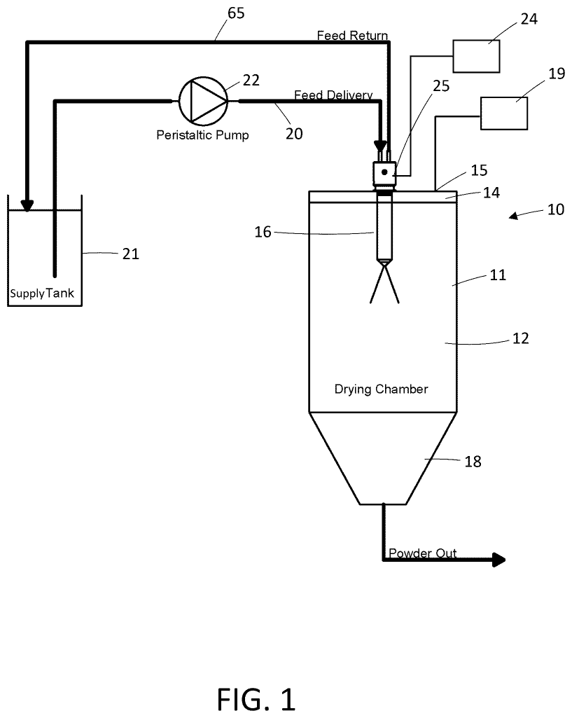

FIG. 2 is an enlarged longitudinal section of a spray nozzle assembly according to the invention utilized in the spray drying system shown in FIG. 1 with a piston controlled shut off head in a fluid spray tip open position;

FIG. 3 is a longitudinal section of the spray nozzle assembly similar to FIG. 2 with the piston controlled shut off head in a fluid spray tip closed position;

FIG. 4 is a longitudinal section of the illustrated spray nozzle assembly circumferentially offset from the sections of FIGS. 2 and 3, showing the high voltage connector for electrically charging the liquid flow and pneumatic inlets for controlling movement of the shut off head piston between fluid spray tip open and closed position;

FIG. 5 is an enlarged fragmentary section of the downstream end of the illustrated spray nozzle assembly shown in FIG. 2;

FIG. 6 is an enlarged fragmentary section of the downstream end of the spray nozzle assembly as depicted in FIG. 3;

FIG. 7 is an enlarged fragmentary perspective of an upstream end of the illustrated spray nozzle assembly;

FIG. 8 is an enlarged fragmentary perspective of the downstream end of the illustrated spray nozzle assembly; and

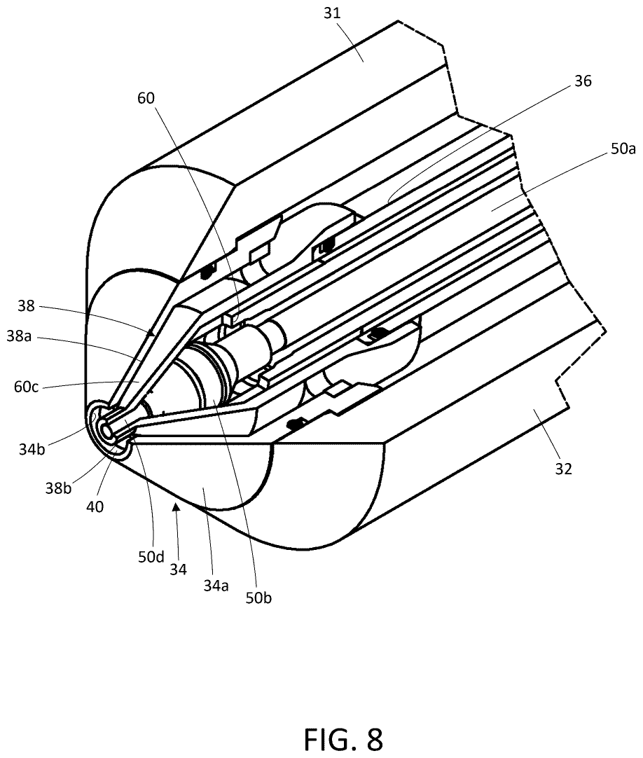

FIG. 9 is a further fragmentary perspective of a downstream end of the illustrated spray nozzle assembly.

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF THE PREFERRED EMBODIMENT

Referring now more particularly to the drawings, there is shown an illustrative spray drying system 10 in accordance with the invention that includes a processing tower 11 in the form of an upstanding cylindrical structure that defines a drying chamber 12, a top closure arrangement in the form of a cover or lid 14 for the drying chamber 12 having a heating air inlet 15 and a liquid spray nozzle assembly 16 mounted therein, and a bottom closure arrangement in the form of a powder collection cone 18 into which dried powder is directed. The heating air inlet 15 is coupled to a heating air supply 19 and the spray nozzle assembly 16 has a fluid delivery line 20 coupled to a fluid supply in the form of a fluid supply tank 21 in this case containing a solids containing fluid. The fluid is directed from the fluid supply tank 21 to the spray nozzle assembly 16 by means of an appropriate pump 22, such as a peristaltic pump, in the fluid delivery line 20. Atomizing gas from an atomizing gas supply 24 is directed to an atomizing gas inlet 25 of the spray nozzle assembly 16 for enhancing atomization of fluid discharging from the spray nozzle assembly 16. Solids dried in the drying chamber 12 into powder form progress into the powder collection cone 18 for direction to an appropriate powder collection chamber while drying gas may be directed through a filter system for reuse. The drying chamber 12 and powder collection cone 18 preferably are made of stainless steel, and the top cover 14 in this case centrally supports the spray nozzle assembly 16 over the drying chamber 12.

The illustrated spray nozzle assembly 16 is an electrostatic spray nozzle assembly for directing a spray of electrostatically charged droplets into the drying chamber 12 for quick and efficient drying of the solids containing liquid into dried powder form. The illustrated spray nozzle assembly 16 has a nozzle body 30 supported in the cover 14 and having an outer atomizing gas tube 31 coupled to a side thereof by a threaded connection 32. The atomizing gas tube 31 in this case includes an atomizing gas cap 34 having an inwardly tapered conical section 34a formed with a downstream opening 34b.

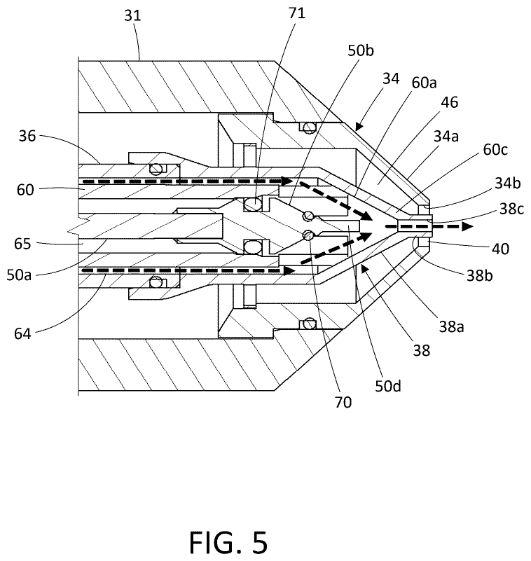

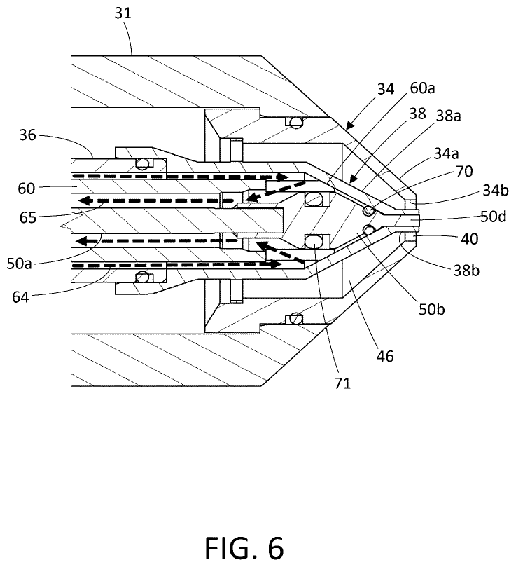

A fluid delivery tube 36 is supported centrally within the atomizing gas tube 31 and has a fluid spray tip 38 affixed to a downstream end centrally within the atomizing gas cap 34. The fluid spray tip 38 has an inwardly tapered conical section 38a within the atomizing gas cap conical section 34 with a forwardly extending smaller diameter nose 38b having a downstream fluid discharge orifice 38c supported in the central opening 34b of the atomizing gas cap 34. The fluid spray tip nose 38b and gas cap opening 34b define an annular atomizing gas discharge orifice 40 in surrounding relation to the fluid spray tip discharge orifice 38a (FIGS. 5 and 6).

For delivering fluid to the fluid delivery tube 36, the upstream end of the fluid delivery tube 36 in this case is supported within an annular fluid delivery manifold 42 that in turn is supported within a central opening 44 of the nozzle body 30. The illustrated fluid delivery manifold 42 defines an upstream annular chamber 42a adjacent a downstream end of the fluid delivery line 20 that is in fluid communication between the fluid delivery line 20 and the fluid delivery tube 36 via an annular passage 42b in the fluid delivery manifold 42 adjacent an upstream end of the fluid delivery tube 36. Hence, fluid from the fluid supply tank 21 may be directed in a fluid spray tip 38 via the fluid delivery line 20, fluid delivery manifold annular chamber 42a and passage 42b, and fluid delivery tube 36.

The outer atomizing gas tube 31 and fluid delivery tube 36 in this case define an annular atomizing gas passage 45 therebetween. The atomizing gas passage 45 communicates between the atomizing gas inlet 25 in the nozzle body 30 and a converging atomizing gas passage 46 between conical sections downstream 34a, 38a of atomizing gas cap 34 and the fluid spray tip 38 for directing atomizing gas through the annular discharge orifice 40 simultaneously with the discharge of fluid from the fluid spray tip discharge orifice 38c.

For controlling the discharge of fluid from the fluid spray tip 38, a piston assembly 50 is centrally disposed within the fluid delivery tube 36. The piston assembly 50 includes a shuttle connecting rod 50a having a shut off head 50b at a downstream end and a shuttle piston 50c affixed to an upstream end. The shuttle piston 50c is supported for movement in a piston chamber 54 in this case defined by an upstream annular chamber 30a of the nozzle body 30 and a manifold end cap 55 supported within the nozzle body opening 40 on an upstream side of the fluid delivery manifold 42.

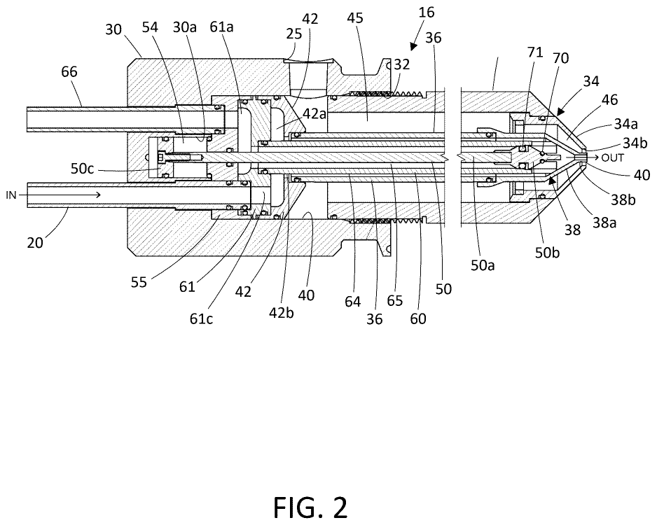

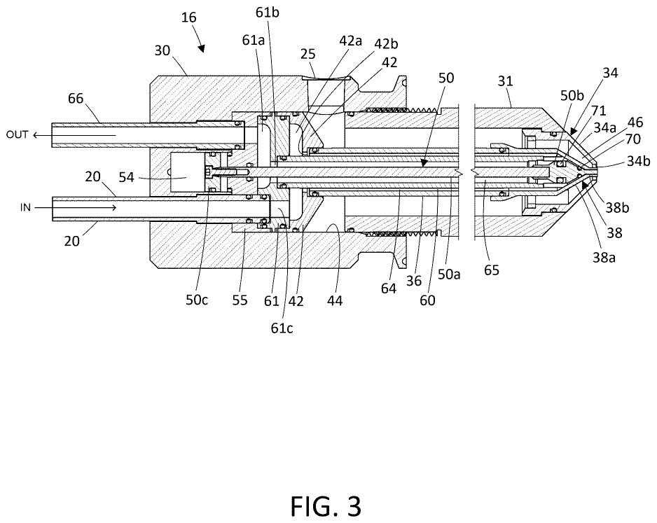

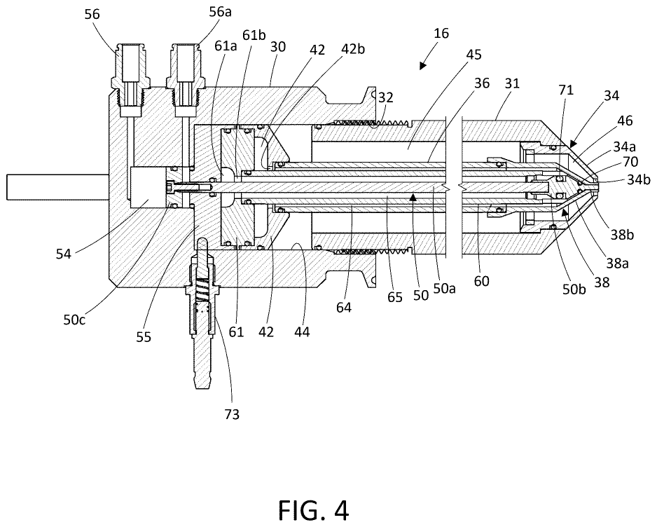

For controlling movement of the shuttle connecting rod 50a and shut off head 50b between fluid spray tip open and closed positions a pneumatic control system is provided that includes pneumatic inlets 56, 56a each connected to a pressurized gas source for communicating pressurized gas to the piston chamber 52 on opposite sides of the shuttle piston 50c (FIG. 4). Directing pressurized gas to the pneumatic inlet 56a forces the shuttle piston 50c in an upstream direction for moving the shuttle rod 50a and shut off head 50b to a fluid spray tip open position (FIGS. 2 and 5), while directing pressurized gas to the pneumatic inlet 56 forces the shuttle piston 50c in a downstream direction moving the shuttle connecting rod 50a and shut off head 50b to a fluid spray tip closed position (FIGS. 3, 4 and 6).

Hence, it can be seen that when the shuttle piston 50c is retracted with the fluid spray tip 50b in the open position, fluid from the delivery line 20 communicates through the fluid delivery manifold chamber 42a and annular passage 42b, fluid delivery tube 36 and about the retracted shuttle head 50b for discharging fluid from the fluid spray tip 38. At the same time, as indicated above, atomizing gas is from the atomizing gas inlet 25 is directed through an annular passage 45 defined between the outer atomizing gas tube 31 and the fluid delivery tube 36 for direction through a converging annular passage 46 between the fluid spray tip and atomizing gas cap conical sections 38b, 34a for discharge from the annular gas discharge orifice 40 for interaction and atomization of liquid discharging from the fluid spray tip discharge orifice 38c.

In accordance with an important feature of the present embodiment, when the shuttle connecting rod and shut off head are moved to a fluid spray tip closing position a unique fluid flow passage system through the spray nozzle assembly prevents the formation fluid dead zones within the spray nozzle assembly that would allow solids to fall out of suspension from the fluid and collect, buildup, and create clogging within the fluid delivery system that would impede efficient operation of the spray nozzle assembly. To this end, a fluid return tube 60 is concentrically supported within the fluid delivery tube 36 about the shuttle connecting rod 50a with a downstream end supported within the conical section 38b of the fluid spray tip 38 and an upstream end centrally supported within a fluid return manifold 61 disposed in the annular nozzle body opening 40 in interposed relation between the fluid delivery manifold 42 and a manifold end cap 55. The concentric mounting of the fluid return tube 60 within the fluid delivery tube 36 defines the fluid delivery passage as an annular passage 64 between and substantially along the entire lengths of the fluid delivery and fluid return tubes 36, 60. With the shuttle connecting rod 50a disposed centrally within the fluid return tube 60, the fluid return tube 60 defines an annular fluid return passage 65 along and about the connecting rod 50a the length of the shuttle connecting rod 50a.

The fluid return manifold 61 in this case defines an upstream annular chamber 61a that communicates between a fluid return line 66 to the fluid supply tank 21 and the fluid return tube 60 via a small diameter annular manifold passage 61b between the fluid return manifold 61 and the shuttle connecting rod 50a (FIG. 3). The fluid return tube 60 in this instance has a chambered downstream end 60a angled consistent with the conical section 38a (FIGS. 5 and 6) of the fluid spray tip 38 for supporting the fluid return tube 60 concentrically within the fluid spray tip 38 and the fluid delivery tube 36. For ensuring immediate and reliable fluid flow shut off of the fluid spray tip 38 when the shut off connecting rod 50a and shut off head 50b are moved to the fluid spray tip closed position, the shut off head 50b carries an annular sealing ring 70 engageable with the fluid spray tip 38 adjacent its discharging end.

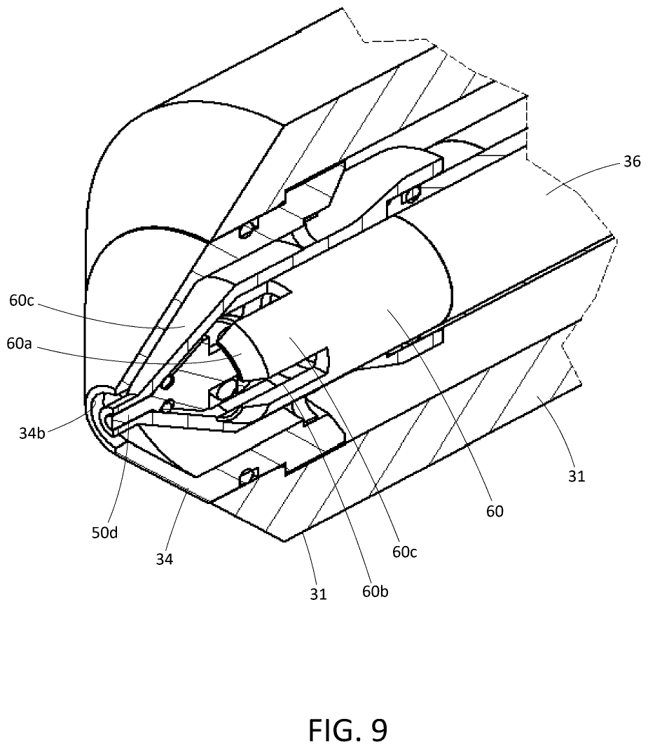

In keeping with this embodiment, for enabling fluid to communicate from the fluid delivery tube 36 to the fluid return tube 60 during movement of the shut off head 50b to the fluid spray tip closed position for the immediate recirculation of fluid along the length of the spray nozzle assembly, the fluid return tube 60 is formed with a plurality of circumferentially spaced flow passage opening in the form slots 60b (FIG. 9) adjacent the end thereof that permit passage of liquid from the fluid delivery tube 36 to the fluid return tube 60 and in turn to the fluid return manifold annular chamber 61a and fluid return line 66 via the annular passage 61b. A plurality of fluid return tube protrusions 60c defined by the slots 60b (FIG. 9) in this case serve to support the downstream end of the fluid return tube 60 within the fluid spray tip 38 and movement of the shut off head 50b between fluid spray tip open and close positions. It will be seen that when the shut off head 50b is retracted to its fluid spray tip open position, as depicted in FIGS. 2 and 5, a larger diameter sealing O-ring 71 carried by the shut off head 50b upstream of a smaller diameter O-ring 70 engages an uninterrupted inside surface of the fluid return tube 60 upstream of the slots 60b for preventing passage of fluid into the fluid return tube 60 from the fluid delivery tube 36 during spraying.

Upon movement of the shut off head 50b to the fluid spray tip closed position, the larger diameter sealing O-ring 71 on the shut off head 50b is moved adjacent a downstream end of the protrusions 60c and fluid return tube 60 simultaneously with the shut off head smaller diameter O-ring 70 closing the fluid passage to the spray tip discharge orifice 38c. Such movement of the shut off head 50b opens the flow passages 60b for immediate direction and recirculation of the fluid from the fluid delivery tube 36 to the fluid return tube 60 and along the length of the spray nozzle assembly for return to the fluid supply tank 21 via the fluid return line 66. The shuttle shut off head 50b further has a forwardly extending needle 50d configured to clear out the discharge orifice 38b of the fluid spray tip 38 of material build up when moved to the fluid spray tip closed position. Fluid redirected to the feed tank 21 can be continuously agitated for redirection to the spray nozzle assembly 16 via the fluid delivery line 20.

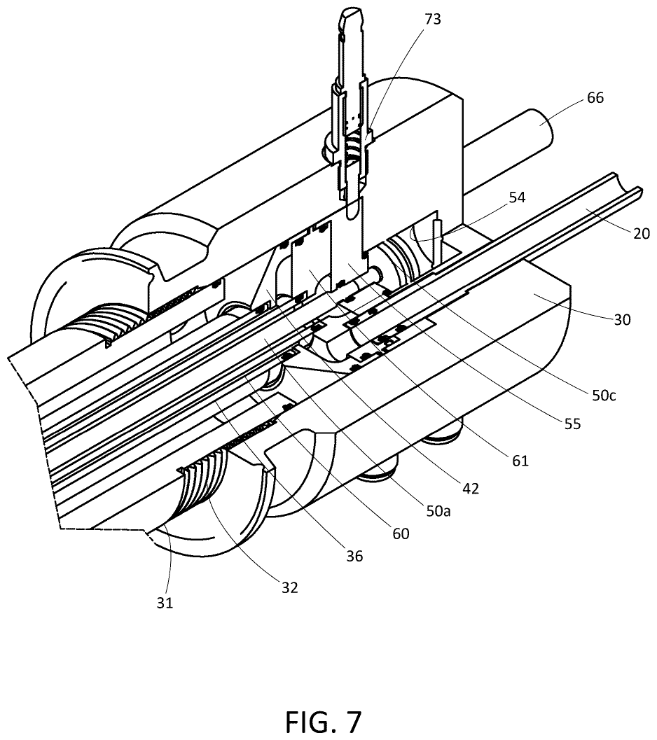

To facilitate spraying of fine liquid particles for enhanced spray drying, the spray nozzle assembly is adapted for more efficient and complete electrostatic charging of the discharging spray. To this end, in the illustrated embodiment, a high voltage connector 73 (FIGS. 4 and 7) is connected to the nozzle body 30 for charging the manifold end cap 55. While the nozzle body 30, atomizing gas tube 31, and atomizing gas cap 34 may be made of non-conductive plastic or like material, all essential components of the spray nozzle assembly that defines the liquid flow passageways within the spray nozzle assembly be electrically charged are metallic. To this end, the manifold end cap 55 coupled to the high voltage connector 73 is mounted in stacked electrical conducting relation to the fluid return manifold 61 and fluid delivery tube 42, which in turn are in conductive relation to the fluid delivery and return tubes 36, 60, the fluid spray tip 38, the shuttle connecting rod 50a and shut off head 50b. Hence, fluid passage through the spray nozzle assembly, both during spraying with the piston shut off head 50b in an open position and during fluid recirculation with the shut off head 50b in a fluid spray tip closed position, is subject to electrostatic charging. The electrically conductive components of the spray nozzle assembly preferably are made of stainless steel that effectively carry the electrical charge while protecting against corrosive materials. Such electrostatic charging has been found to enhance liquid particle formation for enabling efficient spraying of even high solids containing fluids.

From the foregoing, it can be seen that a spray drying system is provided that is operable for more efficient and effective drying of high solids containing fluids without undesirable clogging during shut off conditions. More particularly, a spray nozzle assembly is provided in which solids contain fluids are recirculated substantially throughout the spray nozzle assembly during shut off conditions for preventing solids buildup. It will be understood that while the illustrated spray nozzle assembly has particular utility for spraying fluid containing liquids, the term “fluid” is intended to include all liquids, solvents, and slurries, whether or not they include a solids content. Moreover, while the illustrated spray nozzle assembly is an electrostatic spray nozzle assembly with a charging electrode, the spray nozzle assembly can be effectively used for clog resistant spraying of other fluids and slurries without an electrode and electrostatic charging of the dispensed fluid.

What is claimed:

1. A spray nozzle assembly (16) comprising:
a nozzle body (30) having a fluid delivery line (20) coupled to a fluid supply (21) and a fluid return line (66) coupled to said fluid supply (21);
a fluid delivery tube (36) supported by said nozzle body (30);
a fluid spray tip (38) having a fluid discharge orifice (38c) supported at a downstream end of said fluid delivery tube (36);
a fluid return tube (60) supported within said fluid delivery tube (36);
said fluid delivery tube (36) and fluid return tube (60) defining a fluid delivery passage (64) therebetween communicating between said fluid delivery line (20) and said spray tip (38);
said fluid return tube (60) defining a fluid return passage (65) communicating between said spray tip (38) and said fluid return line (66); and
a piston assembly (50) having a shut off head (50b) supported within said fluid return tube (60) for movement between a first retracted position that permits direction of fluid from said fluid delivery line (20) through said fluid delivery passage (64) for discharge from said spray tip discharge orifice (38c) and a second extended position that blocks the flow of fluid from said fluid delivery passage (64) to said spray tip fluid discharge orifice (38c) and enables the direction of fluid from said fluid delivery passage (64) to said fluid return passage (65) and fluid return line (66) for recirculation in said fluid supply (21).

2. The spray nozzle assembly of claim 1 in which said nozzle body (30) has a forwardly extending atomizing gas directing tube (31) in surrounding relation to said fluid delivery tube (36) for defining an atomizing gas passage (45) therebetween communicating with an atomizing gas supply (24), and said atomizing gas directing tube (31) having an annular atomizing gas discharge orifice (40) in surrounding relation to said spray tip discharge orifice (38c) for directing atomizing gas to atomize fluid discharging from said spray tip discharge orifice (38c).

3. The spray nozzle assemble of claim 2 in which said atomizing gas tube (31) includes an atomizing gas cap (34) at a downstream end that defines said annular atomizing gas discharge orifice (40) about said spray tip discharge orifice (38c).

4. The spray nozzle assembly of claim 1 in which said fluid supply (21) is a supply of a solids containing fluid, and when said piston shut off head (50b) is in said second extended position blocking the flow of fluid through said spray tip discharge orifice (38c) fluid directed through said fluid delivery passage (64) and fluid return passage (65) prevents the formation of dead zones within the spray nozzle assembly (16) that would allow solids to fall out of suspension in the fluid and collect and cause clogging within the spray nozzle assembly (16).

5. The spray nozzle assembly of claim 1 in which said piston assembly (50) includes a piston rod (50a) extending centrally through said fluid return tube (60) with said shut off head supported at a downstream end and a piston (50c) affixed to an upstream end, said piston (50c) being selectively positionalble for moving said piston shut off head (50b) between said first retracted and second extended positions, and said fluid return passage (65) is an annular passage about said piston rod (50a).

6. The spray nozzle assembly of claim 1 in which said piston shut off head (50b) has a frustoconical downstream end tapered inwardly in a downstream direction and carries a relatively small diameter O-ring (70) about a downstream end that engages the fluid spray tip (38) and closes said spray tip discharge orifice (38c) when said shut off head (50b) is in said second extended position and a relatively larger diameter O-ring (71) adjacent an upstream end thereof that engages and closes the fluid return tube (60) when said shut off head (50b) is in said first retracted position.

7. The spray nozzle assembly of claim 1 in which said fluid return tube (60) is formed with a plurality of fluid passage openings (60b) adjacent the downstream end thereof, and said piston shut off head (50b) when in said first retracted position enables communication of fluid from said fluid delivery passage (64) through said fluid passage openings (60b) to said spray tip discharge orifice (38c) for discharge from said spray tip discharge orifice (38c) while blocking communication of fluid from said fluid delivery passageway (64) to said fluid return passage (65), and said piston shut off head (50b) when said second extended position blocks communication of fluid from said fluid delivery passageway (64) to and through said spray tip discharge orifice (38c) while permitting fluid flow through said fluid return tube fluid passage openings (60b) to and through said fluid return passage (65) and fluid return line (66) for recirculation in said fluid supply (21).

8. The spray nozzle assembly of claim 7 in which said fluid spray tip (38) has a downstream frustoconical section that tapers inwardly in a downstream direction; said piston shut off head (50b) having a frustoconical downstream end tapered inwardly in a downstream direction that carries a relatively small diameter O-ring (70) adjacent a downstream end and a relatively larger diameter O-ring (71) adjacent a upstream end; and when said piston shut off head (50b) is in said first retracted position said large diameter O-ring (71) is positioned in sufficiently upstream relation to said fluid return tube (60) and said fluid delivery tube fluid passage openings (60b) for preventing the flow of fluid from said fluid delivery tube passage (64) to said fluid return tube (60) while enabling the passage of fluid from said fluid delivery passage (64) to and through said spray tip discharge orifice (38c), and when said piston shut off head (50b) is in said second extended position said smaller diameter O-ring (70) is in sealing engagement with said spray tip (38) for preventing the discharge of fluid from said fluid delivery tube (36) through said spray tip discharge orifice (38c) while said second larger diameter O-ring is positioned in sufficient downstream relation to said return tub fluid passage openings (60b) for enabling passage of fluid flow from said fluid delivery passage (64) through said fluid passage openings (60b) to said fluid return passage (65) and in turn to the fluid return line (66) and fluid supply (21) for recirculation.

9. The spray nozzle assembly of claim 8 in which said fluid return passage openings (60b) in the fluid return tube (60) are defined by a plurality of circumferentially spaced slots in a downstream end of the fluid return tube (60) that define a plurality of circumferentially spaced protrusions (60c).

10. The spray nozzle assembly of claim 9 in which said fluid return tube protrusions (60c) engage said frustoconical section (34a) of said fluid spray tip (38).

11. The spray nozzle assembly of claim 5 in which said piston connecting rod (50a) extends through a manifold (61) mounted within said nozzle body (30) having a first passage (61c) communicating between said fluid delivery line (20) and said fluid delivery tube (36) and a second passage (61a, 61b) communicating between said fluid return tube (60) and said fluid return line (66).

12. The spray nozzle assembly of claim 5 in which said piston connecting rod (50a), piston shut off head (50b), fluid spray tip (38), and fluid delivery and return tubes (36, 60) are in electrically conductive relation to each other, and a high voltage connector (73) for electrically charging said connecting rod (50a) shut off head (50b) fluid spray tip (38) and fluid and delivery tubes (36, 60) such that fluid directed through said spray nozzle assembly both during spraying with said shut off head (50b) in said retracted open position and during fluid recirculation when said shut off head (50b) is in said extended spray tip discharge orifice closing position the fluid is subject to electrostatic charging.

13. The spray nozzle assembly of claim 12 in which said piston connecting rod (50a) is supported within said spray nozzle body (30) by an end cap (55) for relative movement, and said high voltage connector (73) is operable in electrically charging said end cap (55) and in turn said connecting rod (50a), shut off head (50b), fluid spray tip (38), and fluid delivery and return tubes (36, 60).

14. An electrostatic spray nozzle assembly (16) comprising:
a nozzle body (30) having a fluid delivery line (20) coupled to a fluid supply (21) and a fluid return line (66) coupled to said fluid supply (21);
a fluid delivery tube (36) supported by said nozzle body (30);
a fluid spray tip (38) having a fluid discharge orifice (38c) supported at a downstream end of said fluid delivery tube (36);
a fluid return tube (60) supported within said fluid delivery tube (36);
said fluid delivery tube (36) and fluid return tube (60) defining a fluid delivery passage

(64) therebetween communicating between said fluid delivery line (20) and said spray tip (38);
said fluid return tube (60) defining a fluid return passage (65) communicating between said spray tip (38) and said fluid return line (66);
a piston assembly (50) having a shut off head (50b) supported within said fluid return tube (60) for movement between a first retracted position that permits direction of fluid from said fluid delivery line (20) through said fluid delivery passage (64) for discharge from said spray tip fluid discharge orifice (38c) and a second extended position that blocks the fluid from said fluid delivery passage (64) to said spray tip fluid discharge orifice (38c) and enables the direction of fluid from said fluid delivery passage (64) to said fluid return passage (65) and fluid return line (66) for recirculation in said fluid supply (21);
said nozzle body (30) having a forwardly extending atomizing gas directing tube (31) in surrounding relation to said fluid delivery tube (36) for defining an atomizing gas passage (45) therebetween communicating between an atomizing gas supply (24), and said gas directing tube having an annular atomizing gas discharge orifice (40) in surrounding relation to said spray tip discharge orifice (38c) for directing atomizing gas to atomize fluid discharging form said spray tip discharge orifice (38c); and
said piston connecting rod (50a), piston shut off head (50b), fluid spray tip (38), and fluid delivery and return tubes (36, 60) being in electrically conductive relation to each other, and a high voltage connector (73) for electrically charging said connecting rod (50a), shut off piston head (50b), fluid spray tip (38) and fluid and delivery tubes (36, 60) such that fluid directed through said spray nozzle assembly, both during spraying with said shut off head (50b) in said retracted open position and during fluid recirculation when said shut off head (50b) is in said spray tip discharge orifice closing position the fluid is subject to electrostatic charging.

15. The electrostatic spray nozzle assembly of claim 14 in which said piston connecting rod (50a) is supported within said spray nozzle body (30) by an end cap (55) for relative movement, and said high voltage connector (73) is operable in electrically charging said end cap (55) and in turn the said connecting rod (50a), shut off head (50b), fluid spray tip (38), and fluid delivery and return tubes (36, 60).

16. The electrostatic spray nozzle assembly of claim 14 in which said fluid supply (21) is a supply of a solids containing fluid, and when said piston shut off head (50b) is in said second extended position blocking the flow of fluid through said spray tip discharge orifice (38c) fluid directed through said fluid delivery passage (64) and fluid return passage (65) prevents the formation of dead zones within the spray nozzle assembly (16) that would allow solids to fall out of suspension in the fluid and collect and cause clogging within the spray nozzle assembly (16).

17. The electrostatic spray nozzle assembly of claim 14 in which said piston shut off head (50b) has a frustoconical downstream end tapered inwardly in a downstream direction and carries a relatively small diameter O-ring (70) about a downstream end that engages the fluid spray tip (38) and closes said spray tip discharge orifice (38c) when said shut off head (50b) is in said second extended position and a relatively larger diameter O-ring (71) adjacent an upstream end thereof that engages and closes the fluid return tube (60) when said shut off head (50b) is in said first retracted position.

18. An electrostatic spray drying system (10) comprising a processing tower (11) in the form of an upstanding cylindrical structure that defines a drying chamber (12);
a top closure arrangement (14) at an upper end of said drying chamber (12) having a heating air inlet (15) and an electrostatic spray nozzle mounted therein, a bottom closure arrangement (18) into which dried powder is directed, and said heating air inlet (15) being coupled to a heating air supply (19) for directing heated drying air into said drying chamber (12);
said electrostatic spray nozzle assembly (16) includes a nozzle body (30) having a fluid delivery line (20) coupled to a fluid supply (21) and a fluid return line (66) coupled to said fluid supply (20);
a fluid delivery tube (36) supported by said nozzle body (30);
a fluid spray tip (38) having a fluid discharge orifice (38c) supported at a downstream end of said fluid delivery tube (36);
a fluid return tube (60) supported within said fluid delivery tube (36);
said fluid delivery tube (36) and fluid return tube (60) defining a fluid delivery passage

(64) therebetween communicating between said fluid delivery line (20) and said spray tip (38);
said fluid return tube (60) defining a fluid return passage (65) communicating between said spray tip (38) and said fluid return line (66);
a piston assembly (50) having a shut off head (50b) supported within said fluid return tube (60) for movement between a first retracted position that permits direction of fluid from said fluid delivery line (20) through said fluid delivery passage (64) for discharge from said spray tip fluid discharge orifice (38c) and a second extended position that blocks the fluid from said fluid delivery passage (64) to said spray tip fluid discharge orifice (38c) and enables the direction of fluid from said fluid delivery passage (64) to said fluid return passage (65) and fluid return line (66) for recirculation in said fluid supply (21);
said piston connecting rod (50a), piston shut off head (50b), fluid spray tip (38), and fluid delivery and return tubes (36, 60) being in electrically conductive relation to each other, and a high voltage connector (73) for electrically charging said connecting rod (50a), shut off piston head (50b), fluid spray tip (38), and fluid and delivery tubes (36, 60) such that fluid directed through said spray nozzle assembly, both during spraying with said shut off head (50b) in said retracted open position and during fluid recirculation when said shut off head (50b) is in said spray tip discharge orifice closing position the fluid is subject to electrostatic charging, and
during operation of said electrostatic spray drying system with said piston shut off head (50b) in said retracted open position solids in said solid containing fluid dried in said drying chamber are directed to the bottom closure arrangement (18).

19. The electrostatic spray drying system of claim 18 in which said piston connecting rod (50a) is supported within said spray nozzle body (30) by an end cap (55) for relative movement, and said high voltage connector (73) is operable in electrically charging said end cap (55) and in turn the said connecting rod (50a), shut off head (50b), fluid spray tip (38), and fluid delivery and return tubes (36, 60).

20. The electrostatic spray drying system of claim 18 in which said fluid supply (21) is a supply of a solids containing fluid, and when said piston shut off head (50b) is in said second extended position blocking the flow of fluid through said spray tip discharge orifice (38c) fluid directed through said fluid delivery passage (64) and fluid return passage (65) prevents the formation of dead zones within the spray nozzle assembly (16) that would allow solids to fall out of suspension in the fluid and collect and cause clogging within the spray nozzle assembly (16).
